(19) United States
(12) Patent Application Publication
(10) Pub. No.: US 2016/0099625 A1
(43) Pub. Date: Apr. 7, 2016

(54) Electric Motor With Radially Mounted Magnets

(71) Applicant: SPX Corporation, Charlotte, NC (US)

(72) Inventor: Michael T. Landrum, Rockford, IL (US)

(21) Appl. No.: 14/505,152

(22) Filed: Oct. 2, 2014

(51) Int. Cl. H02K 3/47; H02K 5/16; H02K 13/00; H02K 3/28; H02K 9/00

(52) U.S. Cl. CPC H02K 3/47; H02K 3/28; H02K 9/005; H02K 13/006; H02K 5/16

(57) ABSTRACT

An electric device includes: a first set of magnets arranged in an annular array about a central axis of the device; a second set of magnets arranged in an annular array about the central axis of the device; a first carrier supporting the first set of magnets, the first carrier rotatable about the central axis; a second carrier supporting the second set of magnets axially spaced along the central axis from the first set of magnets, the first and second carriers dimensioned to allow the first and second set of magnets to move past each other when the first carrier rotates. A method of moving magnets with respect to each other may also be provided.

### FIELD OF THE INVENTION

The present disclosure relates generally to an electric motor. More particularly, the present disclosure relates to a compact high output electric motor/generator.

### BACKGROUND OF THE INVENTION

Electric motors have been used for a long time for a variety of tasks. Electric motors can be used in commercial, domestic, construction and many other applications for converting electric power into mechanical power. For example, electricity may be converted to shaft power by electric motor. Of course, as one of ordinary skill in the art would understand, and electric motor, if run backwards, can be used as a generator. As a result, mechanical power such as a rotating shaft can be converted into electricity with a generator. Therefore as used in this disclosure, unless specifically indicated, the term electric motor is not meant to be exclusive of a generator which may be substantially the same structure running backwards.

It may be desirable to have more compact electric motors in order to provide additional benefits such as making electric motors smaller and able to provide more output per unit of space taken up by the motor and making the motor more portable due to its decrease in size.

Accordingly, it is desirable to provide a method and apparatus that results an electric motor more compact and smaller compared to conventional electric motors having similar outputs.

### SUMMARY OF THE INVENTION

The foregoing needs are met, to a great extent, by the present disclosure, wherein in one aspect an apparatus is provided that in some embodiments results an electric motor more compact and smaller compared to conventional electric motors having similar outputs.

In accordance with one aspect of the present invention, An electric device includes: a first set of magnets arranged in an annular array about a central axis of the device; a second set of magnets arranged in an annular array about the central axis of the device; a first carrier supporting the first set of magnets, the first carrier rotatable about the central axis; a second carrier supporting the second set of magnets axially spaced along the central axis from the first set of magnets, the first and second carriers dimensioned to allow the first and second set of magnets to move past each other when the first carrier rotates.

In accordance with another aspect of the present invention, a method of moving magnets with respect to each other may include: arranging a first set of magnets in an annular array about a central axis; arranging a second set of magnets in an annular array about the central axis; spacing the first and second set of magnets from each other axially with respect to the central axis; and energizing at least one of the set of magnets to cause one of the sets of magnets to rotate about the central axis and move past the other set of magnets.

In accordance with yet another embodiment aspect of the present invention, an electric device includes: a first set of magnets arranged in an annular array about a central axis of the device; a second set of magnets arranged in an annular array about the central axis of the device; a first means for supporting the first set of magnets, the first means for supporting rotatable about the central axis; a second means for supporting the second set of magnets axially spaced along the central axis from the first set of magnets, the first and second means for supporting the magnets dimensioned to allow the first and second set of magnets to move past each other when the first means for supporting the first set of magnets rotates.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view illustrating an electric motor according to the present disclosure.

FIG. 2 is a perspective view of a portion of the housing of the amount electric motor according to FIG. 1.

FIG. 3 is a perspective view of an armature in accordance with the present disclosure.

FIG. 4 is an exploded view of an electromagnet in accordance present disclosure.

FIG. 5 is an assembled view of the electromagnet of FIG. 4.

FIG. 6 is a cross-sectional view of the armature and shaft in accordance with the present disclosure.

FIG. 7 is a perspective view of a part of the housing containing electromagnets in accordance with the present disclosure.

FIG. 8 is a perspective view of a part of the housing containing electromagnets taken from a different viewpoint then the viewpoint shown in FIG. 7.

FIG. 9 is a perspective view of a part of the housing and a cross-sectional view of the armature mounted to a shaft in an electric motor in accordance with the present disclosure.

FIG. 10 is an end view of the shaft, armature, and housing containing the electromagnets in accordance with an electric motor of the present disclosure.

### DETAILED DESCRIPTION

An embodiment in accordance with the present invention provides an electric motor that arranges the field magnets and armature magnets in a dense relationship. Magnets are arranged in the housing and armature in a radial orientation. Multiple arrays of magnets, some mounted to the armature and others to the housing are radially arranged in arrays about the axis of the armature shaft. Armature mounted arrays alternate with housing mounted arrays of magnets along a length of the shaft axis. The motor is configured to cause the armature (or in some embodiments the housing) to rotate about the shaft axis due to electromagnetic attraction and repulsion between the various armature and housing arrays of magnets. When the electric motor is operating, the field magnet arrays and armature magnet arrays move past each other without contacting each other. Various cooling vents and holes may be located throughout the armature and housing in order to allow air, or any other cooling fluid, to circulate amongst the magnets and cool the motor.

Example aspects and embodiments will now be described with reference to the drawing figures, in which like reference numerals refer to like parts throughout.

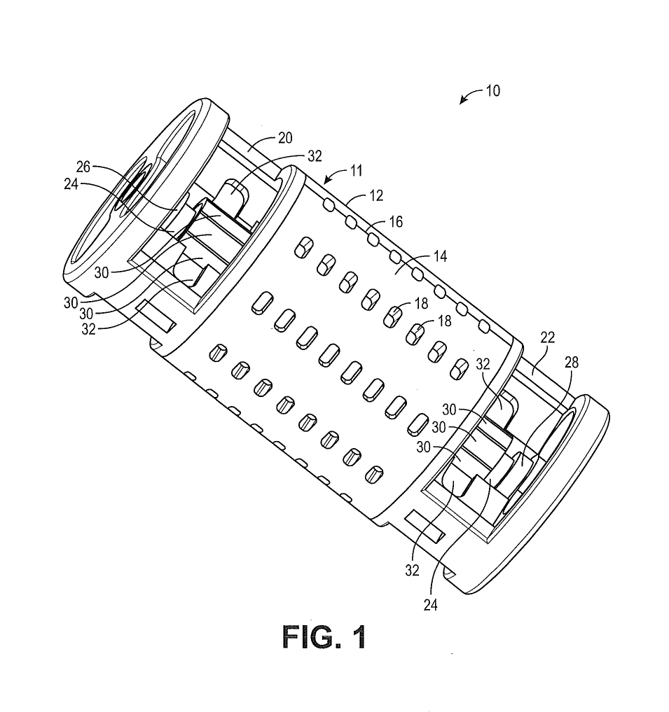

An example embodiment is illustrated in FIG. 1. FIG. 1 illustrates an electric motor 10 which, as discussed above can also be an electric generator. One of ordinary skill in the art after reviewing this disclosure will understand the generators also fall within the scope of the present disclosure. However, for simplicity the apparatus shown in figures will be referred to as a motor 10. The electric motor 10 includes a housing 11. The housing 11 may include a first clamshell 12 and a second clamshell 14. A seam 16 may be located where the first clamshell 12 and the second clamshell 14 come together. In some embodiments, the housing 11 may include cooling vents 18 which are configured to allow air or any other cooling fluid to circulate through the motor 10 in order to provide cooling to the motor 10.

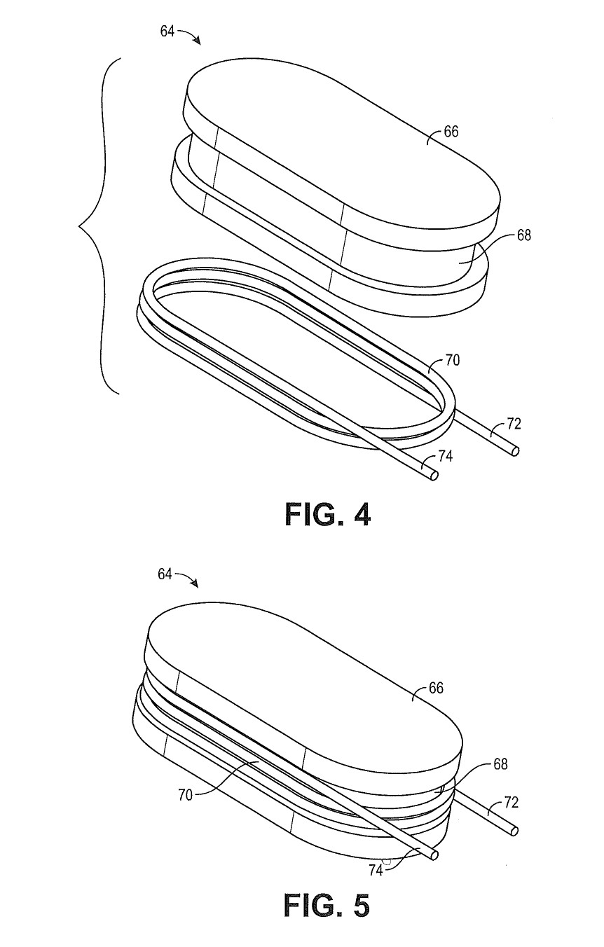

The motor 10 may be equipped with a first end cap 20 and a second end cap 22. The electric motor 10 may also be equipped with a shaft 24 which contacts the end caps 20 and 22 via bearings 26 and 28 respectively. The electric motor 10 may also be equipped with armature commutators 30 and brushes 32. As is well known, the commutators 30 and brushes 32 may control the polarity of various electromagnets 64 (shown and described in more detail with respect to FIGS. 4 and 5). While the illustrated embodiment has commutators and brushes 30 and 32 one of ordinary skill in the art after reviewing this disclosure, will appreciate that other techniques for controlling the polarity of the electromagnets may also be used. For example, in environments that need to be fireproof or spark free, solid-state systems may be used. Other suitable systems and techniques for controlling the polarity may also be used.

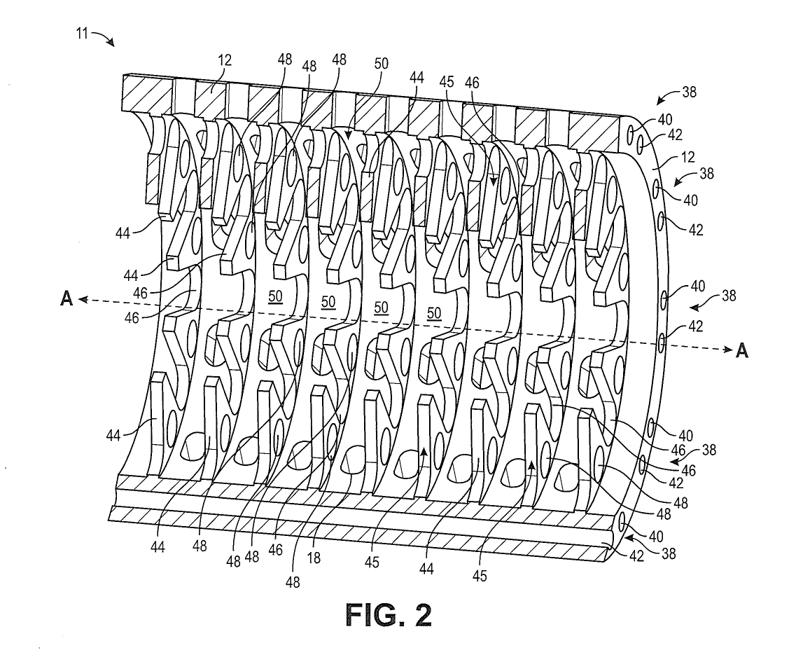

FIG. 2 illustrates an interior portion of one of the clamshells 12 of the housing 11. The clamshell 12 includes sets 38 of holes 40 and 42 extending through the length of the clamshell 12. In some embodiments, the sets 38 of holes 40 and 42 are located in an array based radially from the central axis A-A of the motor 10. These sets 38 may be comprised of groups of two holes 40 and 42.

The clamshell 12 may also contain structure 44 in the form of support ridges 44 for supporting magnets 64 (best shown in FIGS. 4 and 5). The support ridges 44 may define magnet slots 46. In some embodiments and as shown, the magnet slots 46 are U-shaped. In many embodiments the magnet slots 46 will be dimensioned and shaped in order to correspond to the shape of the magnets 64 in order to support the magnets 64 in position. In some embodiments, the support ridges 44 are arranged and configured to have the magnet slots 46 located in an array 45 about the central axis A-A of the motor 10. The support ridges 44 may be axially spaced from each other with spaces 50 in the clamshell 12. The support ridges 44 may also include or define cooling holes 48. The cooling holes 48 allow air or any other cooling fluid to circulate through the motor 10 in order to cool the motor 10. The clamshell 12 may also include cooling vents 18 which will allow air or any other cooling fluid to circulate in and out of the housing 11.

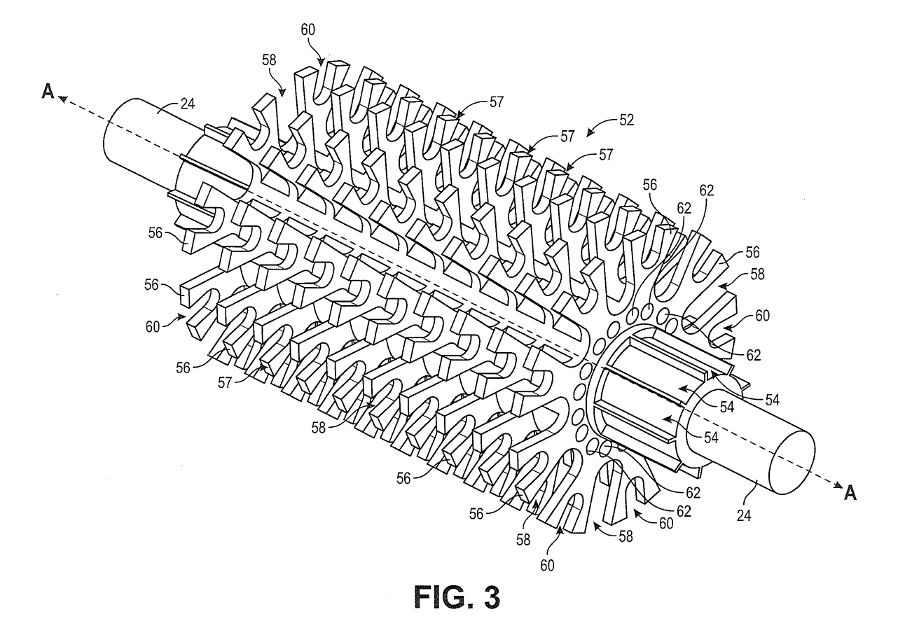

FIG. 3 is a perspective view of an armature 52 in accordance with the disclosure. The armature 52 may be equipped with commutator slots 54 and be integrated with the shaft 24. In other embodiments, the armature 52 may not necessarily be integrated with the shaft 24. Further, as stated above, some embodiments may not use commutators 30 and thus will not need commutator slots 54. The armature 52 also has support fins or ridges 56. The armature support fins 56 may be dimensioned and configured to be arranged in armature radial arrays 57. Each array 57 may be at the scene place along the longitude of the axis A-A and encompasses the axis A-A. The armature support fins or ridges 56 may include slots 58. The slots 58 may be U-shaped as shown in the figures or may have other shapes that are designed to correspond to magnets 64 (see FIGS. 4 and 5) to secure the magnets 64 in position within the support fins 56. The Armature support fins 56 may also define cooling slots 60 which may allow air or any other cooling fluid to circulate about the armature 52.

In some embodiments, the commutator 52 may also define holes 62 extending in an axial direction. In some embodiments the holes 62 are located in an array about the central axis A-A of the motor 10. The holes 62 may be substantially parallel to the axis A-A.

FIG. 4 illustrates an exploded view of an electromagnet 64 that may be used in accordance with the present disclosure. The magnet 64 includes a body portion 66 which defines a coil groove 68. A coil 70 may be made of copper any other suitable conductor. The coil 70 includes two ends 72 and 74. The two ends 72 and 74 may be connected to different conductors in order to energize the coil 70.

FIG. 5 is an assembled view of the magnet 64 illustrated in an exploded view in FIG. 4. The electromagnet 64 includes a body portion 66 defining a coil groove 68 into which a coil 70 having two ends 72 and 74 is located. The particular configuration illustrated in FIGS. 4 and 5 is meant to be exemplary only. Other suitable electromagnet configurations may also be used in accordance with the disclosure.

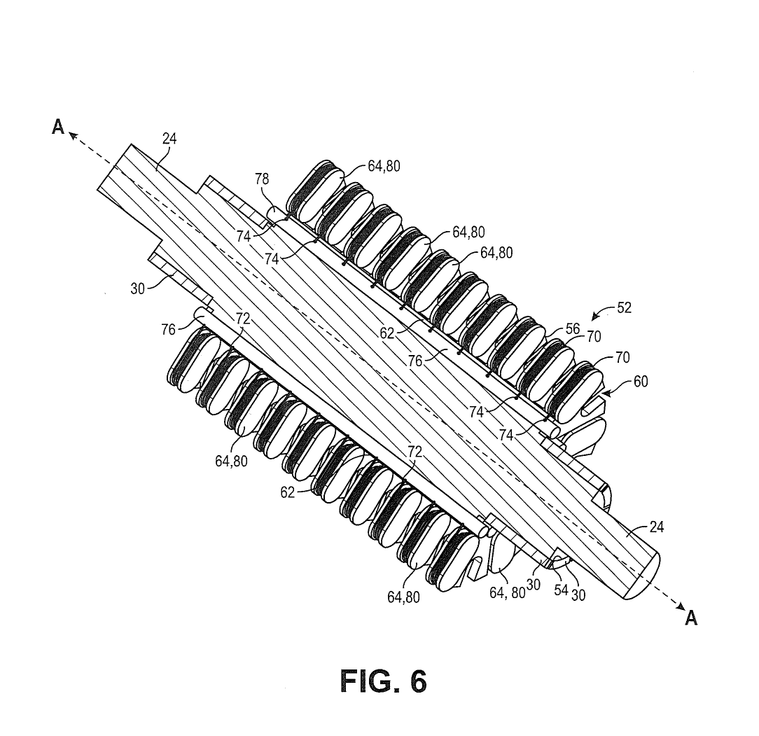

FIG. 6 is a perspective view of an armature 52 having magnets 64 mounted into the armature support fins 56. The armature 52 shown in FIG. 6 is integrated with the shaft 24. Commutators 30 are fit into commutator slots 54 as shown. A first armature rod 76 and second armature rod 78 are conductors. The armature rod 76 and 78 are fit into the holes 62 best shown in FIG. 3. The first and second armature rods 76 and 78 may be grouped in groups of two and are oppositely charged. As shown in FIG. 6, a first end 72 of a coil 70 may be connected to a first armature rod 76 and a second end 74 of the coil 70 may be connected to a second armature rod 78. The armature rods 74 and 78 may be operatively connected to the commutators 30 by electrical connectors (not shown) so that the polarity of the current flowing through the armature rod 74 and 76 may be controlled and thereby control the polarity of the magnets 64. The magnets 64 which are located on the armature 52 may be referred to as armature magnets 80. When the armature 52 rotates the armature magnets 80 will rotate about the axis A-A of the armature 52. The slots 60 not filled by armature magnets 80 are the cooling slots 60.

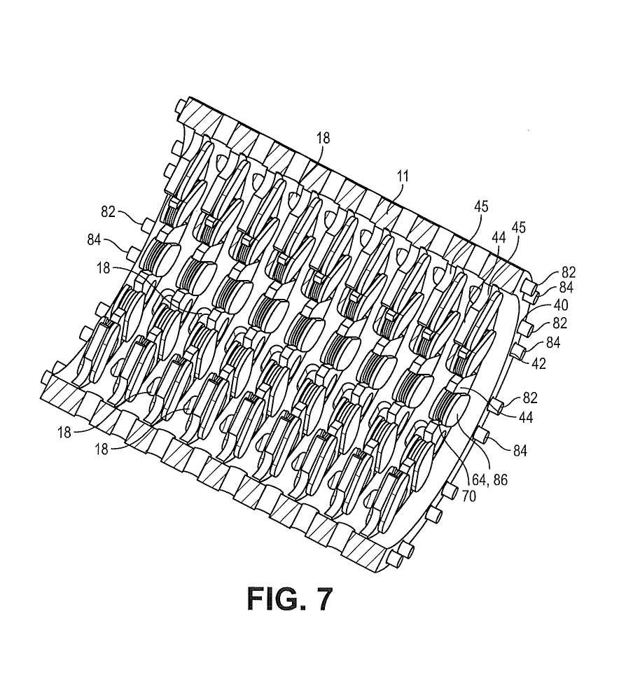

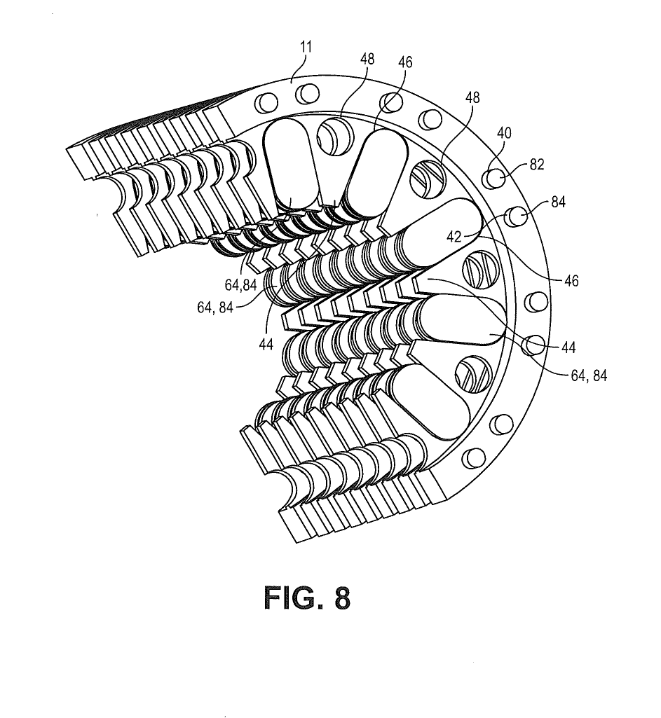

FIGS. 7 and 8 illustrate a portion of the housing 11 having magnets 64 located in the support ridges 44. The magnets 64 are located in annular arrays 45. The two ends 72 and 74 are connected to a first field rod 82 and second field rod 84 respectively in a similar manner that the armature magnets 80 are connected to the first armature rod 76 and second armature rod 78. First field rod 82 and a second field rod 84 are located in the holes 40 and 42 in the housing 11 as shown. Because the two ends 72 and 74 are connected to a first field rod 82 and second field rod 84, controlling the polarity of the first field rod 82 and second field rod 84 the polarity of the field magnets 86 may be controlled. Similar to that described above regarding the first armature rod and second armature rod 76 and 78 being found in groups of two of opposite polarity, the first field rod 82 and second field rod 84 are also located in groups of two having opposite polarity. The cooling holes 48 in the support ridges 44 are shown located between the field magnets 84.

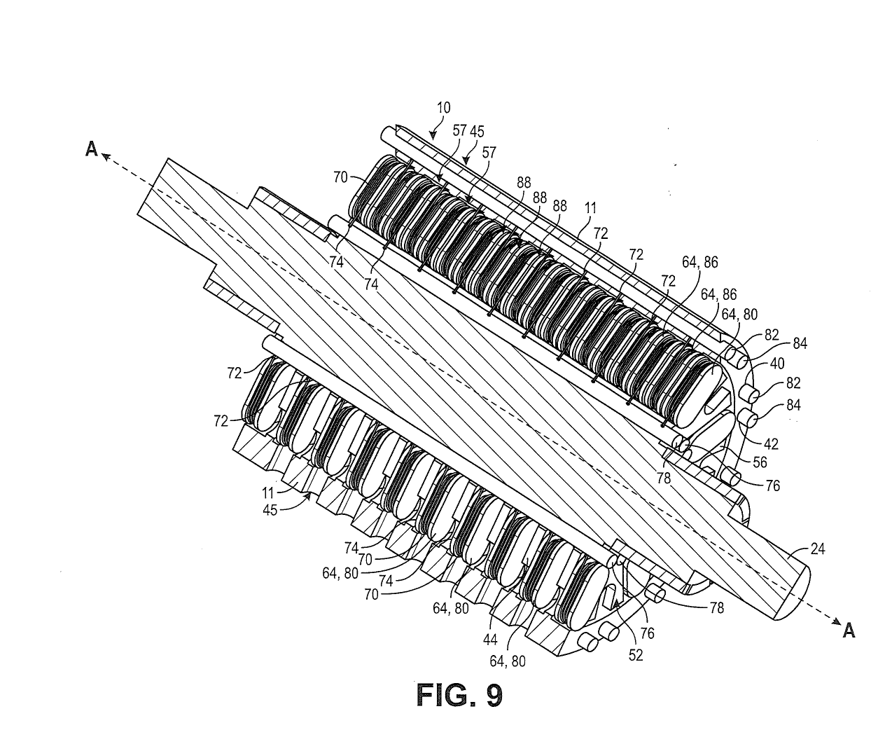

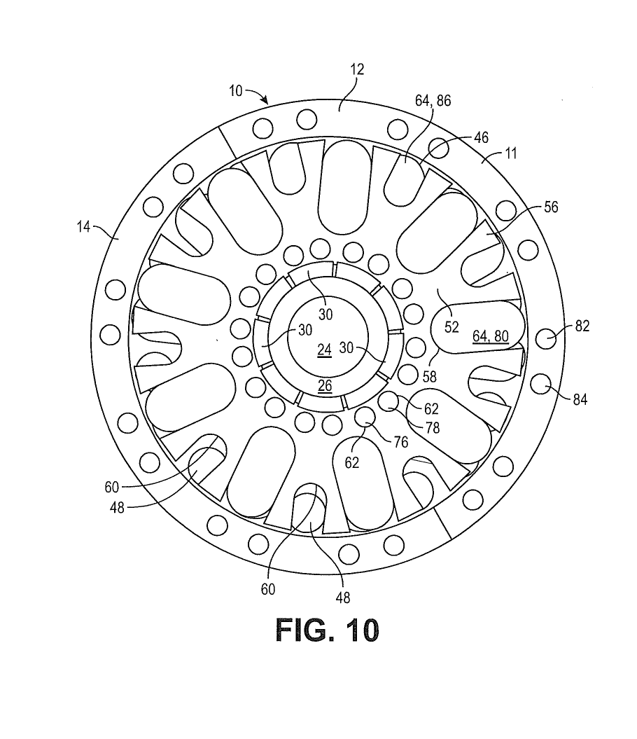

FIGS. 9 and 10 illustrate a motor 10 having the housing 11 installed about the armature 52. FIG. 9 is a cross-sectional view of the motor 10 and FIG. 10 is an end view. With reference to both FIGS. 9 and 10 the shaft 24 is shown supporting the armature 52. The armature magnets 80 are illustrated in arrays 45 arranged about the axis A-A of the armature 52. Field magnets 84 are also located in arrays 57 located radially about the axis A-A. The arrays 45 and 57 of armature magnets 80 and field magnets 86 alternate along the longitudinal axis A-A. The first end 72 of the armature magnet 80 coil 70 attaches to the first armature rod 76 and the second end 74 of the coil 70 of the armature magnets 80 attaches to the second armature rod 78. Likewise, the first ends 72 of the coils 70 of the field magnets 86 are operatively connected to the first field rod 82 and the second ends 74 of the coils 70 of the field magnets 86 are operatively connected to the second field rods 84. Field rods 84 and 82 are located in holes 40 and 42 respectively. The arrays 45 and 57 of magnets 80, 86 are spaced by a gap 88 in order to allow the magnets 80 and 86 to slide past each other.

As the motor 10 operates, the magnets 64 may become hot due to electrical resistance and eddy currents generated within the magnets 64. As a result, it may be desirable to provide cooling to the magnets 64.

In some embodiments, the magnets 64 are wider than the support ridges 44 in the housing 11 and the armature support fins 56. By having the magnets 64 wider than both the armature support fins 56 and the support ridges 44, the magnets 64 are exposed to air or other cooling fluid as the magnets 64 move past each other during the relative rotation between the armature 52 and the housing 11. When the armature 52 and housing 11 rotate with respect to each other, the magnets 64 to encounter moving air which can help cool the magnets 64. Air or other cooling fluid movement through the motor 10 is also facilitated, at least in part, by the cooling vents 18 in the housing 11 and the cooling holes 48 in the housing 11 and cooling slots 60 in the armature 52.

Air or other cooling fluid may be forced axially through the motor 10 by a fan or any other suitable means.

FIG. 10, in particular, illustrates the clamshells 12 and 14 of the housing 10. The commutators 30 are illustrated as being located on the armature 52. The first and second armature rods 76 and 78 are seen located in holes 62. The shaft 24 rests on the bearing 26. The armature cooling slots 60 and cooling holes 48 are illustrated. As the armature 52 rotates with respect to the housing 11, the cooling holes 48 and cooling slots 60 are at times aligned.

By controlling the polarity of the magnets 64, the magnet arrays 45 and 57 can rotate with respect to each other due to magnetic attraction and repulsion between the magnet arrays 45 and 57. While some embodiments as shown discussed herein contemplate that both the armature magnets 80 and the field magnets 86 are electromagnets, in some embodiments either the armature magnets 80 or the field magnets 86 may be permanent magnets 64 and the other set of magnets 64 may be electromagnets 64.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An electric device comprising:
a first set of magnets arranged in an annular array about a central axis of the device;
a second set of magnets arranged in an annular array about the central axis of the device;
a first carrier supporting the first set of magnets, the first carrier rotatable about the central axis;
a second carrier supporting the second set of magnets axially spaced along the central axis from the first set of magnets, the first and second carriers dimensioned to allow the first and second set of magnets to move past each other when the first carrier rotates.

2. The electric device of claim 2, further comprising several sets of magnets arranged in annular arrays on the first carrier and several sets of magnets arranged in an annular arrays on the second carrier and the magnets are arranged such that arrays supported by the first carrier alternate with arrays supported by the second carrier along the central axis.

3. The electric device of claim 1, wherein at least one of the first and second set of magnets are electromagnets.

4. The electric device of claim 3, wherein at least one of the first and second set of magnets are permanent magnets.

5. The electric device of claim 3, further comprising a first set of electrical conduits connected to at least one of the first carrier and second carrier and operatively connected to the electromagnets to at least one of provide polarity and magnetize the electromagnets.

6. The electric device of claim 5, wherein the electrical conduits are configured to change the polarity of the electromagnets.

7. The electric device of claim 5, further comprising a second set of electrical conduits connected to the opposite carrier to which the first set of electrical conduits are connected to and operatively connected to the opposite set of magnets to which the first set of electrical conduits are operatively connected to.

8. The electric device of claim 1, further comprising mounting fins on which at least one of the first and second set of magnets are mounted and the mounting fins are thinner than the magnets mounted to the mounting fins.

9. The electric device of claim 1, further comprising cooling passageways defined by at least one of the first and second carriers.

10. The electric device of claim 9, wherein in the cooling passageways are open in an axial direction with respect the central axis.

11. The electric device of claim 1, further comprising cooling passageways in the second carrier that are opened in a radial direction with respect to the central axis.

12. The electric device of claim 1, wherein the first carrier is a rotatable armature.

13. The electric device of claim 12, further comprising commutators attached to the first carrier.

14. The electric device of claim 13, further comprising brushes operatively connected to the commutators.

15. The electric device of claim 12, further comprising a bearing attached to a shaft portion of the armature.

16. The electric device of claim 12, wherein the second carrier comprises, at least in part, a housing for the electric device.

17. The electric device of claim 1, wherein the electric devices configured to be at least one of an electric motor and a generator.

18. A method of moving magnets with respect to each other comprising:
arranging a first set of magnets in an annular array about a central axis;
arranging a second set of magnets in an annular array about the central axis;
spacing the first and second set of magnets from each other axially with respect to the central axis; and
energizing at least one of the set of magnets to cause one of the sets of magnets to rotate about the central axis and move past the other set of magnets.

19. The method of claim 18 further comprising arranging further sets of magnets in annular arrays about a central axis and some of the sets of magnets in annular arrays have a common polarity and the annular arrays having common polarity alternate axially along the central axis with annular arrays not having the common plurality.

20. An electric device comprising:
a first set of magnets arranged in an annular array about a central axis of the device;
a second set of magnets arranged in an annular array about the central axis of the device;
a first means for supporting the first set of magnets, the first means for supporting rotatable about the central axis;
a second means for supporting the second set of magnets axially spaced along the central axis from the first set of magnets, the first and second means for supporting the magnets dimensioned to allow the first and second set of magnets to move past each other when the first means for supporting the first set of magnets rotates.
